(19) United States
(12) Patent Application Publication
(10) Pub. No.: US 2025/0337091 A1
(43) Pub. Date: Oct. 30, 2025

(54) BATTERY SYSTEM INCLUDING IMPROVED CELL COVER

(71) Applicant: SAMSUNG SDI CO., LTD., Yongin-si (KR)

(72) Inventors: Florian TRIPAUM, Wolfau (AT); Florian Prossnigg, Graz (AT)

(21) Appl. No.: 18/813,899

(22) Filed: Aug. 23, 2024

(30) Foreign Application Priority Data
Apr. 26, 2024 (EP) 24172664.5

(51) Int. Cl. H01M 50/342; H01M 50/262; H01M 50/276

(52) U.S. Cl. CPC H01M 50/3425; H01M 50/262; H01M 50/276

(57) ABSTRACT

1 ABSTRACT

A battery system including: a plurality of battery cells arranged along a stacking direction, each of the battery cells having a venting exit at a venting side thereof for discharging a venting gas stream; and a cover element covering the venting sides of the battery cells to protect the battery cells from the venting gas stream. The cover element including a plurality of individual cell covers respectively covering respective ones of the battery cells. Neighboring ones of the individual cell covers in the cover element are separated from each other by slits extending through the cover element such that each individual one of the cell covers is configured to be torn away individually from the corresponding battery cell by the venting gas stream discharged from the corresponding one of the venting exits.

### CROSS-REFERENCE TO RELATED APPLICATION

The present application claims priority to and the benefit of European Patent application Ser. No. 24/172,664.5, filed on Apr. 26, 2024, in the European Patent Office, the entire disclosure of which is incorporated herein by reference.

### BACKGROUND

### 1. Field

Aspects of embodiments of the present disclosure relate to a battery system.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle “BEV”) or may include a combination of an electric motor and, for example, a conventional combustion engine (a so-called Plugin Hybrid Electric Vehicle “PHEV”). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (e.g., is accommodated in) a casing, and electrode terminals, which are positioned on the outside of the casing, establish an electrically conductive connection to the electrodes. The casing may have, for example, a cylindrical or rectangular shape.

A battery module is formed of a plurality of battery cells connected together in series or in parallel. For example, the battery module is formed by interconnecting the electrode terminals of the plurality of battery cells, in a number and configuration depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or respectively the battery cells, may be configured in a series, parallel, or a mixture of both to provide the desired voltage, capacity, and/or power density. Components of a battery pack include the individual battery modules and interconnects, which provide electrical conductivity between the battery modules.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the energy stored is released very suddenly. In extreme cases, thermal runaway can cause battery cells to explode and start a fire. In minor cases, it can cause battery cells to be damaged beyond repair.

When a battery cell is heated above a critical temperature (e.g., above about 150° C.) the battery cell can transition into thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is therefore flammable and potentially toxic. The vented gas also causes gas-pressure to increase inside the battery pack. In the worst case, the high temperatures lead to the process (e.g., the thermal runaway) spreading to neighboring cells and a fire in the battery pack. At this stage, the fire is difficult to extinguish.

A conventional venting concept for a battery module is to let the venting gas stream discharged from the battery cell(s) expand into the battery housing and escape through a housing venting valve to the outside (e.g., to the environment surrounding the battery housing). This concept, however, causes the venting gas stream to heat up the components inside the battery housing, such as the other battery cells. Furthermore, particles from the venting gas stream may deposit onto the battery cells, which may lead to thermal propagation and may incite thermal runaway in adjacent battery cells. To protect the battery cells, a cover element may be provided covering at the venting side of the battery cells.

Such a cover element may include venting openings in the form of through-holes that are aligned with the venting exits of the battery cells to let the venting gas stream pass through the cover element in case of a thermal runaway of one of the covered battery cells. After passing through the cover element, particles of the discharged venting gas stream may deposit onto the cover element. Thereby, however, particles of the venting gas stream may pass through another venting opening of the cover element that is aligned with the venting exit of one of the battery cells and may thus enter the other battery cell. This may lead to thermal propagation to the other battery cell and, in the worst case, incite a thermal runaway in the other battery cell.

To address this problem, a cover element may be provided that is thin enough to rupture at sections aligned with and corresponding in shape with the venting exits of the battery cells when exposed to the high pressure of the venting gas stream exiting one of the covered battery cells affected by a thermal runaway. Also, the cover element may, at sections aligned with the venting exits, include perforations corresponding to the venting exits to provide a breaking point (e.g., a predetermined breaking point) that may rupture when exposed to the high pressure of the venting gas stream.

These solutions, however, risk that the cover element may be bent outwardly by the pressure of the venting gas stream before the cover element ruptures, causing the cover element to lift off the battery cells adjacent to the affected battery cell so that venting gas might possibly flow underneath the cover element towards the adjacent battery cells. This may lead to thermal propagation in the adjacent battery cells and, in the worst case, incite a thermal runaway in the adjacent battery cells.

### SUMMARY

According to embodiments of the present invention, a battery system which more securely handles a thermal runaway of one or more of its battery cells is provided.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes: a plurality of battery cells arranged along a stacking direction, each of the battery cells having a venting exit at a venting side thereof for discharging a venting gas stream; and a cover element covering the venting sides of the battery cells to protect the battery cells from the venting gas stream. The cover element including a plurality of individual cell covers respectively covering respective ones of the battery cells. Neighboring ones of the individual cell covers in the cover element are separated from each other by slits extending through the cover element such that each individual one of the cell covers is configured to be torn away individually from the corresponding battery cell by the venting gas stream discharged from the corresponding one of the venting exits.

According to an embodiment of the present disclosure, the cover element may be formed in one piece from a sheet material, and the individual cell covers may be formed in the sheet via slitting.

According to an embodiment of the present disclosure, the cover element may be a mica sheet.

According to an embodiment of the present disclosure, the cell cover may have end portions that extend around electrode terminals of the battery cells and connect the individual cell covers to each other.

According to an embodiment of the present disclosure, each individual cell cover may extend over more than 50% of the venting side of the corresponding battery cell.

According to an embodiment of the present disclosure, each of the individual cell covers may have a material weakening portion aligned with the venting exit of the corresponding battery cell.

According to an embodiment of the present disclosure, the material weakening portion may include a perforation.

According to an embodiment of the present disclosure, the battery system may further include a cell carrier element fixing the cover element against the venting sides of the battery cells.

According to another embodiment of the present disclosure, an electric vehicle including the battery system as described above is provided.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective exploded view of a battery system according to an embodiment of the present disclosure.

FIG. 2 is a schematic top view of a cover element of the battery system shown in FIG. 1.

FIG. 3 is a schematic sectional view of the battery system shown in FIG. 1 showing some of the battery cells and the cover element.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may include metallization, for example, surface metallizations and/or pins, and/or may include conductive polymers or ceramics. Further electrical energy might be transmitted via wireless connections, for example, by using electromagnetic radiation and/or light.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a plurality of battery cells. The battery cells may be accommodated inside a battery housing of the battery system. The battery cells may be arranged, or stacked, along a stacking direction to form one or more cell stacks. The battery cells may be interconnected via an electrical connector, for example, busbars, contacting respective electrode terminals of the battery cells to form one or more battery modules/battery packs. The battery cells may be arranged to form one or more battery packs, and in each battery pack, the battery cells may be electrically interconnected, for example, in series and/or in parallel. Multiple of these battery packs may form a battery module. The battery cells may be, for example, prismatic cells.

Each of the battery cells includes a venting exit at a venting side of the battery cell, which may be a terminal side of the battery cells at where the electrode terminals of the battery cells are disposed. Each venting exit is configured to allow for a venting gas stream to be discharged from the respective battery cell during a thermal runaway of this battery cell. Venting valves may be provided at (or in) the venting exits, which may open upon a reference pressure (e.g., a predetermined pressure) being exceeded.

The battery system further includes a heat-resistant cover element, or cover sheet, that is arranged to cover the plurality of battery cells at their venting sides. For example, the cover element may cover the top side of the battery cells. In some embodiments, the cover element covers all of the battery cells of the plurality of battery cells; for example, the cover element extends over the venting sides of all of the battery cells of the plurality of battery cells.

The cover element includes a plurality of individual cell covers. The cell covers are individual in that exactly one cell cover is provided for each of the battery cells that are covered by the cover element. Thus, each of the individual cell covers is arranged to cover one battery cell from among the plurality of battery cells in a one-to-one relationship. For example, in some embodiments, every battery cell has its own individual cell cover. All the individual cell covers, however, are part of the cover element. The individual cell covers are distinguished from one another via slits. For example, neighboring individual cell covers are separated from each other by slits penetrating (or extending) through the cover element. In other words, the individual cell covers are formed from the cover element by forming slits in the cover element. These slits are longitudinal cuts or openings that extend through the cover element. Thus, the slits may be provided by (or formed by) cutting/slitting the cover element. The slits may be provided by cutting/slitting the cover element between neighboring battery cells. The slits may be distributed along (e.g., may be adjacent along) the stacking direction and extend perpendicular to the stacking direction. Each slit may extend along a longitudinal side of the battery cells. The slits may extend between electrode terminals of the battery cells. The individual cell covers may be interconnected by end portions of the cover element, for example, portions at where the slits do not extend. The cover element and, thus, its individual cell covers, are heat-resistant and may be made of, or may consist of, a heat-resistant material.

If one of the battery cells is affected by a thermal runaway, a venting gas stream is discharged from the affected battery cell via its venting exit. Because the venting exit of the affected battery cell is covered by one of the individual cell covers, pressure builds up by the venting gas stream until the individual cell cover cannot withstand the pressure. Consequently, the individual cell cover gets torn away (e.g., bursts or ruptures) due to the venting gas stream. Due to the slits, the individual cell covers are configured to get torn away, or blown away, individually from the covered battery cell by the pressure of the discharged venting gas stream exiting the covered venting exit. The individual cell covers may get torn away individually such that they do not affect neighboring individual cell covers during this process, that is, such that they do not take (or tear or rupture) neighboring individual cell covers with them. In other words, the individual cell covers are separated, or decoupled, from each other via the slits such that each individual cell cover may get torn away by a venting gas stream that exits the venting exit of the respective battery cell that is covered by the individual cell cover without affecting, for example, lifting, adjacent individual cell covers. Thus, only the individual cell cover covering the battery cell experiencing thermal runaway is torn away while the individual cell covers of the other battery cells of the plurality of battery cells are not. Thus, the venting gas stream cannot get between the cover element and another one of the battery cells. The cover element with its remaining individual cell covers protects the other battery cells from the discharged venting gas stream. Thus, the cover element shields the covered battery cells from the venting gasses and products discharged by the affected battery cell.

Thus, as the individual cell covers get torn away separately, the cover element according to embodiments of the present disclosure mitigates the risk that the cover element is bent outwardly by the pressure of the venting gas stream and, thus, prevents the venting gas stream from flowing underneath the cover element towards adjacent battery cells. This effectively prevents thermal propagation and, thus, thermal runaway of further battery cells.

According to an embodiment, the cover element is formed in/as one piece from a sheet material, and the individual cell covers are formed in the sheet via slitting. That is, the cover element may be formed from a single piece of sheet material with the slits, and thus, the individual cell covers are formed by slitting, or cutting, the cover element. This provides for simple manufacturing of the cover element.

According to an embodiment, the cover element is a mica sheet. That is, the sheet material may be a mica sheet. In other words, the cover element may be formed in one piece from a mica sheet. The cover element, and therefore the individual cell covers, may thus include mica. Mica refers to mica silicate minerals. The slits may be formed by cutting/slitting the mica sheet. Thus, the individual cell covers may be made of mica. Mica sheets are heat-resistant so that the cover element may withstand any particles from the venting gas stream being deposited onto the cover element. Also, a mica sheet may be a suitable material for allowing the individual cell covers to be torn away by the venting gas stream.

According to an embodiment, the cover element has end portions which surround electrode terminals of the battery cells and connect the individual cell covers to each other. The electrode terminals of the battery cells may be arranged at opposite ends of the venting side of the respective battery cell. The cover element may, with its end portions, cover the venting sides around the areas at where the electrode terminals are disposed. The electrode terminals are not covered by the cover element but instead extend (or are exposed) through the cover element, for example, via through-holes (or openings) in the cover element. The through-holes for the electrode terminals may be cut into the cover element. The individual cell covers may be disposed between the opposite end portions of the cover element and may be interconnected by the end portions, which are portions at where the slits do not extend. The cover element may, thus, protect an entire (top) side of the battery cells including the area surrounding the electrode terminals.

According to an embodiment, each individual cell cover covers a major part of (e.g., a majority of) the venting side of the corresponding battery cell. For example, each individual cell cover may cover more than about 50%, more than about 60%, more than about 70%, or more than about 80% of the venting side, for example, the top side, of the corresponding battery cell. For example, each individual cell cover may cover the entire venting side, or top side, of the respective battery cell aside from the electrode terminals, which may be disposed at the opposite ends of the venting side of the battery cell. The individual cell covers covering the major part of the venting side of the respective battery cells protects the respective battery cells and allows for the venting side of the respective battery cell to be exposed over a large area when the individual cell cover is torn away by the venting gas stream exiting the venting exit of the respective battery cell.

According to an embodiment, each of the individual cell covers has a material weakening portion opposite (e.g., aligned with) the venting exit of the battery cell that is covered by the individual cell cover. According to an embodiment, the material weakening portion is (or includes) a perforation. Thus, the individual cell covers may, at sections opposite the venting exits, include material weakening portions (such as perforations) corresponding to the venting exits to provide a breaking point (e.g., a predetermined breaking point) that may rupture when exposed to the high pressure of the venting gas stream. The material weakening portion may have a shape corresponding to the underlying venting exit. Such material weakening portions may ensure that the venting gas stream can leave (or exit) the underlying battery cell that is affected by the thermal runaway. The venting gas stream may rupture the material weakening portion of the individual cell cover covering the affected battery cell and may also tear away the individual cell cover, at least in part. Due to the slits, however, the venting gas stream will not lift off adjacent individual cell covers and, thus, the venting gas stream cannot reach adjacent battery cells.

According to an embodiment, the battery system further includes a cell carrier element fixating the cover element against the venting sides of the battery cells. The cell carrier element may be connected to a battery frame and/or the battery housing of the battery system and may provide structural stability. The cell carrier element may cover the cover element and the battery cells. The cell carrier element may press the cover element against the venting side of the battery cells to ensure a reliable connection between the cover element and the venting side of the battery cells during a thermal runaway. Further elements may be disposed between the cell carrier element and the cover element such as, for example, a flexible printed circuit for providing an outside electrical connection to the battery cells and/or touch protection elements.

Embodiments of the present disclosure also provide an electric vehicle including a battery system as described herein, for example, as a traction battery.

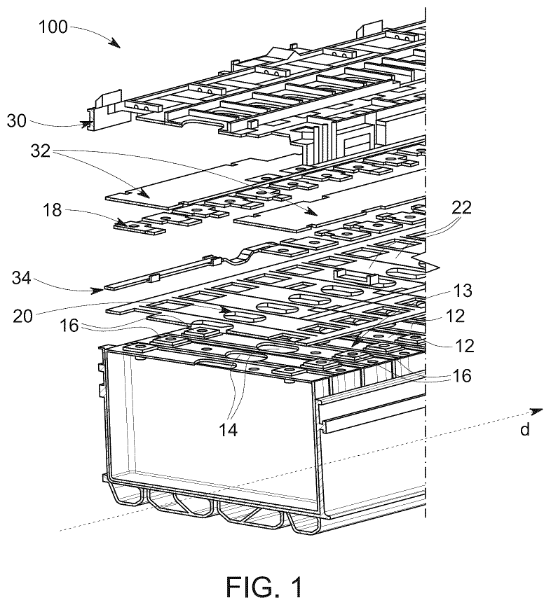

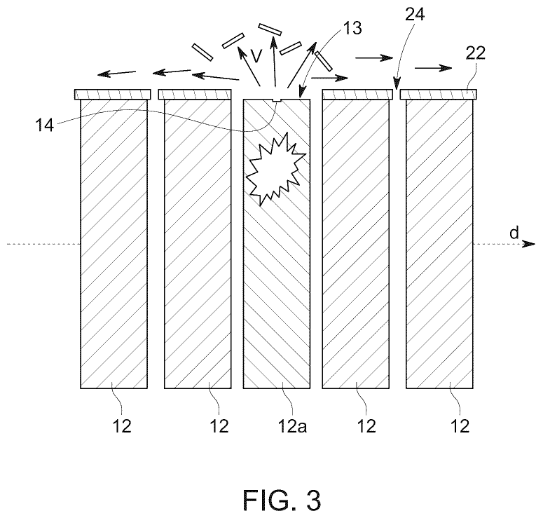

FIG. 1 shows a battery system 100 according to an embodiment of the present disclosure including a plurality of battery cells 12 that are arranged along a stacking direction d to form a cell stack. Each of the battery cells 12 includes, at a venting side thereof, a venting exit 14 for discharging a venting gas stream V (see, e.g., FIG. 3) in case of a thermal runaway. Each of the venting exits 14 may include a venting valve. The venting sides of the battery cells 12 may be a top side 13 of the battery cells 12. Each battery cell 12 includes electrode terminals 16 respectively at opposite ends of the top side 13. The electrode terminals 16 of different battery cells 12 may be interconnected via busbars 18. A flexible circuit 34 may be connected to the busbars 18 to provide an outwards (or external) electrical connection. Further, a touch protection element 32 may be disposed on the busbars 18 and electrode terminals 16. The plurality of battery cells 12, and the further elements, may be arranged inside a battery housing.

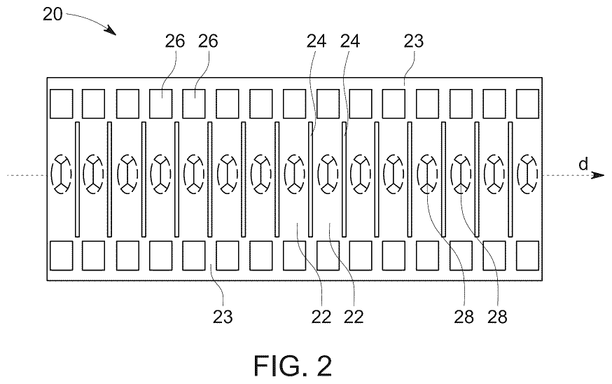

A heat-resistant cover element 20, which may be made as a one-piece mica sheet, is disposed on the battery cells 12 at their venting sides. The cover element 20 is shown from above in FIG. 2. The cover element 20 covers the plurality of battery cells 12 at their top side 13 and may be pressed onto the battery cells 12 via a cell carrier element 30 that may be connected to the battery housing. The cover element 20 includes a plurality of individual cell covers 22, and each individual cell cover 22 is arranged to cover one battery cell 12 from among the plurality of battery cells 12. Thus, each of the battery cells 12 has its own individual cell cover 22. The individual cell covers 22 cover a major part of (e.g., most of or a majority of) the top side 13 of the battery cells, for example, more than about 60% of the top side 13 and including the venting exits 14.

The individual cell covers 22 are separated from each other by slits 24 penetrating through (e.g., extending through) the cover element 20. The slits 24 may be distributed along the stacking direction d and may extend perpendicular to the stacking direction d as shown in FIG. 3. The slits 24 may be provided by cutting/slitting the mica sheet that constitutes the cover element 20. By cutting the slits 24 into the one-piece cover element 20, the individual cell covers 22 are formed in the cover element 20. Cutouts that form through-holes 26 are formed at end portions 23 of the cover element 20 through which the electrode terminal 16 of the battery cells 12 are exposed (or protrude). The end portions 23, thus, surround the electrode terminals 16 of the battery cells 12 and connect the individual cell covers 22 to each other.

In case of a thermal runaway occurring in one of the battery cells 12, a venting gas stream V leaves (e.g., exits) the venting exit of the battery cell 12 affected by the thermal runaway at the top side 13 (see, e.g., FIG. 3). The venting gas stream V thereby exerts pressure onto the individual cell cover 22 disposed above the venting exit 14 such that the individual cell cover 22 gets torn away individually (e.g., individually ruptures) from the affected battery cell 12′. The individual cell cover 22 may get torn to pieces during this process as shown schematically in FIG. 3. The way for the venting gas stream V is then free so that the venting gas stream V may spread (e.g., may flow) into a venting channel above the cover element 20. Because of the slits 24, only the one single individual cell cover 22 that covers the affected battery cell 12a is torn away, not the other individual cell covers 22 covering the neighboring battery cells 12. The other individual cell covers 22 stay in place and may continue to protect the covered battery cells 12 from the venting gas stream V. For example, particles from the venting gas stream V may deposit onto the other individual cell covers 22 without damaging the below battery cell 12.

Each of the individual cell covers 22 may include a perforation 28 (see, e.g., FIG. 2) as a material weakening portion disposed opposite (e.g., aligned with) the venting exit 14 of the battery cell 12 that is covered by the individual cell cover 22. These perforations 28 may rupture above the affected battery cell 12a because of the discharged venting gas stream V, which may ease (or may improve) the flow of the venting gas stream V. Nevertheless, the individual cell cover 22 may get torn away at least partly by the venting gas stream V.

### SOME REFERENCE SYMBOLS

12 battery cells
12a affected battery cell
13 top side of battery cells
14 venting exits
16 electrode terminals
18 busbars
20 cover element
22 individual cell covers
24 slits
26 through-holes receiving electrode terminals
28 perforation
30 cell carrier element
32 touch protection
34 flexible circuit
100 battery system
V venting gas stream

What is claimed is:

1. A battery system comprising:
a plurality of battery cells arranged along a stacking direction, each of the battery cells having a venting exit at a venting side thereof for discharging a venting gas stream; and
a cover element covering the venting sides of the battery cells to protect the battery cells from the venting gas stream, the cover element comprising a plurality of individual cell covers respectively covering respective ones of the battery cells,
wherein neighboring ones of the individual cell covers in the cover element are separated from each other by slits extending through the cover element such that each individual one of the cell covers is configured to be torn away individually from the corresponding battery cell by the venting gas stream discharged from the corresponding one of the venting exits.

2. The battery system as claimed in claim 1, wherein the cover element is formed in one piece from a sheet material, and
wherein the individual cell covers are formed in the sheet via slitting.

3. The battery system as claimed in claim 1, wherein the cover element is a mica sheet.

4. The battery system as claimed in claim 1, wherein the cover element has end portions extending around electrode terminals of the battery cells and connecting the individual ones of the cell covers to each other.

5. The battery system as claimed in claim 1, wherein each one of the individual cell covers extends over more than 50% of the venting side of the corresponding battery cell.

6. The battery system as claimed in claim 1, wherein each of the individual cell covers has a material weakening portion aligned with the venting exit of the corresponding battery cell.

7. The battery system as claimed in claim 6, wherein the material weakening portion comprises a perforation.

8. The battery system as claimed in claim 1, further comprising a cell carrier element fixing the cover element against the venting sides of the battery cells.

9. An electric vehicle comprising the battery system as claimed in claim 1.
